(19) United States
(12) Patent Application Publication
(10) Pub. No.: US 2023/0237353 A1
(43) Pub. Date: Jul. 27, 2023

(54) Machine Learning Based Predictive P-F Curve Maintenance Optimization Platform and Associated Method

(71) Applicant: RAMwright Consulting Co., LLC, Cranberry Township, PA (US)

(72) Inventors: Gary Josebeck, Cranberry Township, PA (US); Arun Gowtham, Toronto (CA)

(21) Appl. No.: 18/101,520

(22) Filed: Jan. 25, 2023

Related U.S. Application Data
(60) Provisional application No. 63/302,877, filed on Jan. 25, 2022.

(51) Int. Cl. G06N 7/00; G06N 20/00

(52) U.S. Cl. CPC G06N 7/00; G06N 20/00

(57) ABSTRACT

A reliability engineering software tool and associated method for scheduling maintenance events of at least one industrial asset comprises at least one identified physical mechanism of failure for the at least one asset and at least one identified precise evidence for each identified physical mechanism of failure for the at least one asset; a monitor for each identified precise evidence for each identified physical mechanism of failure for the at least one asset over time to obtain multiple inputs for each identified precise evidence for each identified physical mechanism of failure for the at least one asset; a machine learning based tool dynamically plotting a P-F curve based upon the monitoring of each identified precise evidence for each identified physical mechanism of failure for the at least one asset over time; and a schedule of maintenance events created based upon the dynamically plotted P-F curve of at least one asset.

### RELATED APPLICATION

This application claims the benefit of U.S. provisional patent application Ser. No. 63/302,877, filed Jan. 25, 2022, and titled “Machine Learning Based Predictive P-F Curve maintenance Optimization Platform and Associated Method” which application is incorporated herein by reference in its entirety.

### BACKGROUND OF THE INVENTION

### 1. Field of the Invention

This invention generally relates to P-F Curve Maintenance Optimization Platform and Associated Method.

### 2. Background Information

Machines are never built to run forever, but they can last a lot longer than one may expect if properly maintained. Machine maintenance is an essential component to any industrial operation, but all too often, these processes are neglected, if not ignored entirely. While it may seem like a hassle or expensive, having a reliability centered maintenance program in place can do wonders for the lifespan of machines and avoid massive costs.

Reliability centered maintenance program often implement what is well known as a P-F curve. The P-F curve has become an essential component to any reliability centered maintenance program, and being able to understand it can help extend the lifespan of machines. P-F Curves are ubiquitous in the maintenance departments of industries, where it is used to explain the concept of an asset exhibiting symptoms of a failure before it experiences failure.

The International Society of automation, for a representative example, describes that the “P-F curve is a way of representing an asset's behavior or condition before it has reached a failed state. It illustrates an asset's progression toward failure. On the chart, the x-axis represents the time to failure, starting with an asset's installation, and the y-axis represents an asset or component's resistance to failure. Potential failure (PF) indicates a detectable state of failure, or the point at which degradation begins. Functional failure (FF) is when the asset or component has reached a failed state or no longer performs satisfactorily.

The most important part of the P-F curve is the P-F interval, which represents the time between when potential failure is detected in an asset and when it reaches the failed state. The length of the P-F interval is largely determined by the technology used to detect failure.”

The P-F Curve is one of the most covered topics in the Reliability Engineering field, since its proposal it has been adapted by the maintenance teams in various industries. It has evolved into an over-arching idea to incorporate many unrelated Maintenance and Reliability concepts, thereby complicating its applicability for everyday use. Recommendations from the Reliability-Centered Maintenance framework includes Inspection tasks on assets to prompt a maintenance action, but the misinterpretation of the P-F Curve often results in miss-timing of the inspection or of the tool used, or of the parameter documented.

This P-F curve has often been labeled as the effective way to plan maintenance programs. Though it is correct, the relentless push for its use using non-destructive prognostics tools has changed its meaning and interpretation by many end-users. Few curves are being drawn with “vibration analyses” marked only in the region after a potential failure giving a misleading guide that this tool can be applied only after a failure has started.

There remains a need for a properly based P-F Curve Maintenance Optimization Platform.

### SUMMARY OF THE INVENTION

One aspect of the present invention provides a reliability engineering software tool for scheduling maintenance events of at least one industrial asset comprising: at least one identified physical mechanism of failure for the at least one asset and at least one identified precise evidence for each identified physical mechanism of failure for the at least one asset; a monitor for each identified precise evidence for each identified physical mechanism of failure for the at least one asset over time to obtain multiple inputs for each identified precise evidence for each identified physical mechanism of failure for the at least one asset; a machine Learning based tool dynamically plotting a P-F curve based upon the monitoring of each identified precise evidence for each identified physical mechanism of failure for the at least one asset over time; and a schedule of maintenance events created based upon the dynamically plotted P-F curve of at least one asset.

One aspect of the present invention provides a reliability engineering software method for scheduling maintenance events of at least one industrial asset comprising: Identifying at least one physical mechanism of failure for the at least one asset and at least one precise evidence for each identified physical mechanism of failure for the at least one asset; Monitoring each identified precise evidence for each identified physical mechanism of failure for the at least one asset over time to obtain multiple inputs for each identified precise evidence for each identified physical mechanism of failure for the at least one asset; dynamically plotting a P-F curve based with a machine learning tool based upon inputs including the monitoring of each identified precise evidence for each identified physical mechanism of failure for the at least one asset over time; and scheduling of maintenance events based upon the dynamically plotted P-F curve of at least one asset.

These and other advantages of the present invention will be clarified in the following description taken together with the following figures.

### BRIEF DESCRIPTION OF THE FIGURES

FIG. 1 is a schematic representation of a P-F Curve for item's degradation, based on predetermined parameters, used for planning maintenance operations in the maintenance optimization platform according to the present invention.

FIG. 2 is a schematic representation schematically illustrating the relationship of identifiable physical mechanism and precise evidence in developing a P-F Curve of FIG. 1.

FIG. 3 is a schematic representation of a P-F Curve used for planning maintenance operations in the maintenance optimization platform according to the present invention illustrating inspection or operation frequency and net P-F interval.

FIG. 4 is a schematic representation of a dynamic P-F Curve used for planning maintenance operations in the maintenance optimization platform according to the present invention.

FIG. 5 is a schematic framework of implementing machine learning for creating a dynamic P-F Curve used for planning maintenance operations in the maintenance optimization platform according to the present invention.

FIG. 6 is a schematic representation of a series of distinct fatigue level based P-F Curves used for planning maintenance operations in the machine learning based maintenance optimization platform according to the present invention.

FIG. 7 is a schematic representation of the development of a multi-variant P-F Curve used for planning maintenance operations in the machine learning based maintenance optimization platform according to the present invention.

FIG. 8 is a schematic representation of predicted or forecasted parameters of a P-F Curve used for planning maintenance operations in the machine learning based maintenance optimization platform according to the present invention.

### BRIEF DESCRIPTION OF THE PREFERRED EMBODIMENTS

The present invention begins by highlighting the fundamentals of the P-F Curve, as originally formulated, to train the users of the present invention for its use in everyday maintenance operations. The first aspect to understand the present invention is to go into detail on the foundations of the P-F Curve, the terms, and its definitions. The present invention also defines how to choose the setup of these curves for an application. Following the steps described herein will enable maintenance personnel to generate a P-F Curve and use the insight to plan maintenance work. The user(s) of the platform of the present invention may be interchangeably referenced as a reliability engineer (RE), operator, maintenance team, and/or maintenance personnel.

A second component of the present invention combines the fundamentals of the P-F curves with Machine Learning techniques to form the platform of the present invention and pushes the boundaries of maintenance optimization. The present invention platform described herein supplements the traditional P-F Curve with Machine Learning by using the asset's performance data; to garner information in real time; to estimate its behavior; to use as feedback to improve the setup. This causes the curve to evolve into a dynamic plot and enhance the detection of failure by utilizing multiple parameters instead of a univariate.

Here are the following terms that are used in our description of the machine learning based predictive P-F curve platform of the present invention

P-F Curve Estimate (P_{E}-F_{E}): A P-F curve that has been generated before real-time data is integrated, and based upon a set of historical failure data, test data, or a combination of both. This Pe-Fe is used to establish Point P, Point F, the P-F Interval, Net P-F Interval, and the maintenance strategies with frequencies that are applicable for this failure mode, mechanism, and “precise evidence” parameter. It is denoted as (P_{E}-F_{E}).

P-F Curve Forecast (P_{F}-F_{F}): As real-time data is available and integrated, a new forecasted curve is generated with new Points PF and FF established based on asset performance, parameter conditions, and other data.

Potential Failure Estimate (P_{E}): The original point on the P-F Curve Estimate that designates when “failure is imminent” based on the failure mode, mechanism, and chosen parameter.

Potential Failure Forecast (P_{F}): The new point on the P-F Curve Forecast that designates when action should be taken to prevent Functional Failure based upon the P-F Curve Decay Rate Ratio.

Functional Failure Estimate (F_{E}): The point on the P-F Curve Estimate that designates when Functional Failure occurs.

Functional Failure Forecast (F_{F}): The point on the P-F Curve Forecast that designates when Functional Failure occurs. This is the same point on the “Y” axis as P-F Curve Estimate.

Dynamic or Predictive P-F Curve: A P-F Curve Forecast that is routinely updated or “forecasted” as new data is integrated.

P-F Curve Decay Rate Ratio (PFDRR): The dividend is the P-F Curve Estimate divided by the divisor P-F Curve Forecast. The resulting quotient=PFDRR=P_{E}−F_{E}/P_{F}-F_{F}. Decay rate PFDRR is used to determine the rate of change difference between P-F Curve Estimate and P-F Curve Forecast and to set Point P_{F} on the curve accordingly.

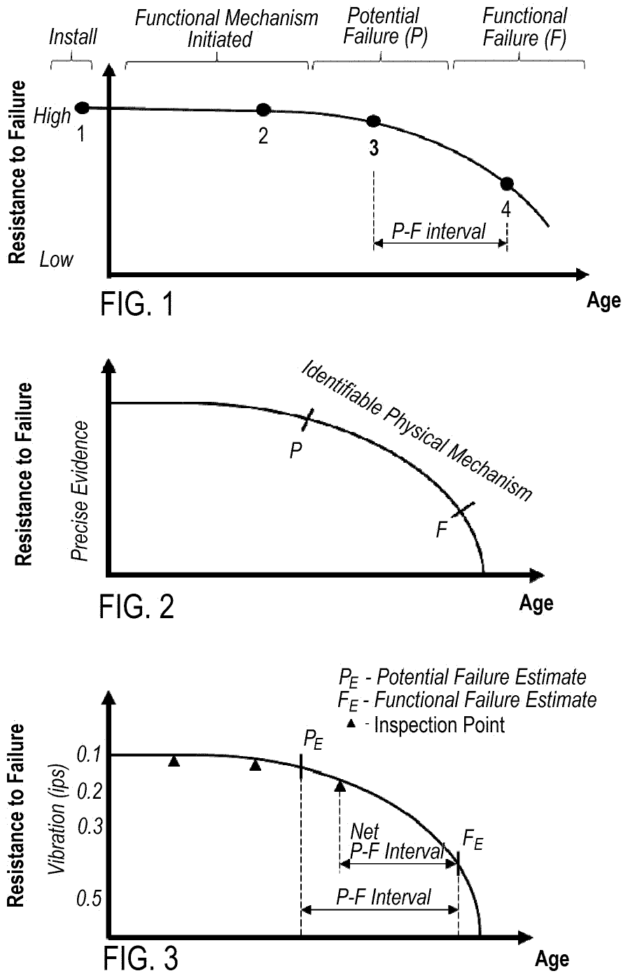

The P-F Curve traces an item's degradation, based on predetermined parameters such as vibration or temperature, from a condition of high “resistance to failure” to one of low “resistance to failure” (Y axis) over the item's operating time or cycles or age (X axis). This is shown in FIG. 1.

As the term “resistance to failure” implies, an item moving along the curve, over time, becomes less and less able to resist failure until it ultimately fails to perform its function to the degree specified.

The two main points on the P-F Curve are the “P” and “F” points, where the P stands for Potential Failure, and the F stands for Functional Failure. A failure is simply described as “an unsatisfactory condition”; with a Functional Failure defined as “the inability of an item (or the equipment containing it) to meet a specified performance standard” and a Potential Failure is defined as “an identifiable physical condition which indicates a functional failure is imminent”. For further background on these aspects see F. S. Nowlan, et al, “Reliability-Centered Maintenance”, United Airlines, 1978; and John Moubray, ‘Reliability-Centered Maintenance”, 2^{nd} Edition, The Aladon Network, 1997. Within the platform of the invention the RE will describe the physical condition at the Potential Failure point as the mechanism leading to the failure mode, example: abrasive wear (mechanism) ultimately leading to a seized bearing (failure mode).

A Potential Failure is often inaccurately described today as “the point on the P-F Curve at which degradation begins” or “the point at which a defect can be detected”. While it is true that P is the point at which functional failure is imminent, the “degradation” (i.e., failure mechanism) initiates earlier on the curve and may be evident (e.g., a small crack); but its condition is still within acceptable limits and therefore no corrective action is required. As a result of this misunderstanding, Point P is often believed to be “given” to us by a default condition such as “crack identified”, when in practice Point P is chosen by the Reliability Engineer as the limit by which, if no corrective action is taken, the functional failure (F) is imminent within the timeframe estimated on the P-F Curve. The elapsed time from the Points P to F is called the P-F Interval (see FIG. 1) and it is the “age” it takes for an item to deteriorate from the Potential Failure condition to Functional Failure. The dots represent points on the P-F Curve where events occur. These points occur within the zones of the curve as described.

Developing a P-F Curve Estimate

To develop a P-F Curve estimate in the platform of the invention the operator first needs to establish an item's functions, then the operator or Reliability Engineer can explore how the item fails to meet these performance expectations as functional failures. An example of a primary function for a pump is “to pump water at 100 gpm+0/−5 GPM at 100 PSI” and a secondary function is “to contain water without leaks”. A Functional Failure then may be expressed as “cannot pump water greater than or equal to 95 GPM at 100 PSI” and another is “cannot pump water at all”. The causes for these losses of functions are called Failure Modes. Of the many failure modes, one of them causing the secondary functional failure may be a “seized bearing”. The Reliability Engineer (RE) must understand the failure mode(s) to determine the identifiable physical mechanism(s) and the precise evidence (PMPE) by which the mechanisms are recognized, indicating that a functional failure is imminent. FIG. 2 shows this relationship.

Once the identifiable physical mechanisms can be understood and recognized, the RE must choose a point on the curve to denote the Potential Failure limit. The optimal limit for P must be a point that will allow the maintenance department sufficient time to take corrective action and restore resistance to the item prior to the functional failure, while also not correcting an item that still has substantial useful life.

Once the potential failure limit has been determined, the RE should select applicable and effective On-condition tasks to detect these conditions and take corrective action to prevent functional failure of the item when the conditional limits are exceeded.

In the representative case of “seized bearing”, one mechanism leading to this failure mode is “abrasive wear” and can be precisely evidenced via Vibration (IPS, G's, Mils) and Ultrasonic Emissions (dB) among others. The RE should assign these On-condition tasks, or other applicable and effective inspections, to be collected using route-based techniques at a frequency of least ½ the P-F Interval to ensure that the potential failure condition is detected and that corrective actions can be properly planned and scheduled prior to functional failure.

Detecting the moment that the limit at Point P has been reached can be difficult when manually inspecting the conditions using hand-held route-based devices. It is very likely that the limit has already been exceeded by the time the inspection is performed or in worse cases Point P can be missed by as much as the duration of the inspection frequency, example: 30 days for a monthly inspection. The elapsed time between the point of detection of Point P and the Point F is called the Net P-F Interval. This is a more realistic view of how much time an RE has to plan and schedule a corrective action of the item when performing route-based inspections. If the RE waits too long to detect the degradation, the RE may not be able to act in time to prevent the functional failure. For this reason, the RE must ensure that the frequency of inspections is sufficient to allow the maintenance department to properly plan and schedule the corrective action. A best practice inspection frequency is one half the P-F Interval, for example: if the P-F Interval equals eight weeks, then the inspection frequency should be 8 weeks/2, or 4 weeks. If the inspection frequency is fixed, i.e., a vendor contract to come in at a specified frequency, then Point P will need to be adjusted higher on the P-F Curve to accommodate the inspection frequency and still maintain a Net P-F Interval sufficient for maintenance to act.

P-F Curve Estimate Factors

As evident from FIG. 3, inspection frequency is a crucial factor in designing a maintenance strategy from P-F Curve. The inspection interval influences the location of Point P on the curve. There are additional factors that also influence the location of Point P. They are Asset Criticality, Spare Part Lead Time, and Decay Rate.

For an asset that is highly critical in the operations, the RE will choose to set the Point P little earlier to allow for variations in maintenance execution. Similarly, if the Spare Part Lead Time changes, then the team must start the maintenance intervention at an appropriate point of potential failure detection to account for the availability of the spare part. The rate at which the asset's resistance to failure is decaying will have the significant effect on the limit of Point P as explained in the next section.

Decay rate: P_{E} vs P_{F}

An asset's exposure to stress does not always remain constant and may not stay within the designed levels. When a single stress or combined stresses reduce an item's resistance to failure sufficiently, a functional failure will occur sooner. These exposed stresses will reduce the useful life of an item considerably due to the accelerated rate of deterioration. With this increase in the rate of decay, the estimated P-F Interval may no longer apply, and corrective action will be required sooner than normally anticipated

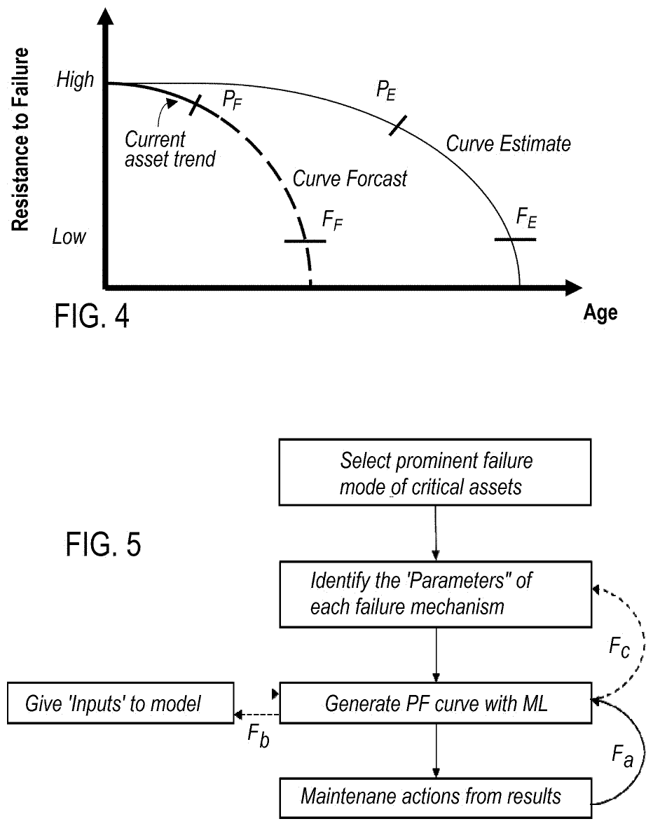

For example, a bearing that is not installed correctly may pass commissioning requirements for initial vibration and temperature but endures accelerated rate of deterioration from the exposed stress. For particulars on variables for this bearing example see J. Lee, H. Qiu, G. Yu, J. Lin, and Rexnord Technical Services (2007). IMS, University of Cincinnati. “Bearing Data Set”, NASA Ames Prognostics Data Repository (http://ti.arc.nasa.gov/project/prognostic-data-repository), NASA Ames Research Center, Moffett Field, Calif. In this scenario, by the time the estimated Point P (P_{E}) is reached, the forecasted remaining life may be reduced by 50 percent or more from the original estimates. Trending the actual rate of deterioration against historical estimates allows new data to plug into the equation. If Point P_{E} hasn't been reached yet, but the rate of change has sufficiently increased, then P_{E} should be moved up to reflect the imminence of the Functional Failure. The new Point P is called Potential Failure Forecast (P_{F}) and reflects conditions on the ground. As P_{F} shifts higher and higher on the P-F Curve, the severity of the preventive maintenance action and its priority must be raised to ensure the work is scheduled and executed prior to Functional Failure. See FIG. 4.

If the Decay Rate of the Estimated P-F Curve is (DR_{E}) and the Decay Rate of the current Forecasted P-F Curve is (DR_{F}), then the ratio of the rates can quickly identify the change in P-F interval.

Decay Rate Ratio=DR_{E}/DR_{F}

If the Decay Rate Ratio>1, then the P-F interval is shrinking and if the Decay Rate Ratio<1, then the P-F interval is expanding. Due to inherent variability in the operation, two curves will always be different in comparison giving different decay rates. Two-sided limits shall be set on the Decay Rate Ratio to trigger a change in the definition of Potential Failure Point, only when its value is significantly out of the average.

An asset's exposure to varying stresses can also be incorporated into its P-F Curve through its S-N Curve (Stress-Life Curve). S-N Curve represents the relation between the accumulation of fatigue cycles and the asset life. Asset exposed to high amplitude stress for a short time and then operated at standard conditions should account for the lost age at the spike. This results in a modified P-F Interval and a modified location of Potential Failure Point to plan maintenance action. Modification of the curve set up should consider the maintenance action performed; a replacement of the asset will restore the P-F Curve whereas a repair will keep the new set up.

While the conventional P-F Curve's use is beneficial, it is only an “estimate” of the future performance and remains static or unchanging throughout its use. Since the curve gets created and adopted for a failure mode based on a set of assumptions and operating conditions, there is no way to update it based on the new operating conditions or stresses on the ground. If any of these conditions change from the historical trend, the P-F Curve and the strategies based upon it may no longer be valid and could lead to an unscheduled downtime event. A better approach in the platform of the present invention is to use Machine Learning that supports real-time optimization of the curve.

Using Machine Learning to Supplement the P-F Curve Models

An efficient maintenance program is one which is continuously being optimized by using new performance data. Research outlines the need for organizations to prepare the collection of real-time data from assets and respond to it throughout its operating life, see A. K. S. Jardine, D. Lin, D. Banjevic, “A review on machinery diagnostics and prognostics implementing condition-based maintenance”, Mechanical Systems and Signal Processing 20 (2006) 1483-1510.

Continuously monitoring for new data throughout the asset life and re-plotting the P-F Curve will stretch the resources of any organization. The platform of the present invention implements the infrastructure of the Industrial Internet of Things (IIoT), wherein numerous sensors can monitor the performance of critical assets and report back instantaneously. Since variability is inherent in all design, using point estimates from one asset to plot the P-F Curve for maintenance planning can be unreliable. Collecting numerous point estimates from a population of assets or from different usage conditions can help establish a baseline P-F Curve with a high confidence interval that will work in most conditions. Machine Learning (ML) tools are applied at this stage to optimize the data and fit a curve. This can be validated as more data is used to train or when the Prediction decisions are verified.

Machine learning tools in the broadest sense are computer algorithms that can improve automatically through experience and by the use of data. Machine learning tools are seen as a part of artificial intelligence. Machine learning algorithms, in general, build a model based on sample data, known as training data, in order to make predictions or decisions without being explicitly programmed to do so. The difference between optimization and machine learning arises from the goal of generalization: while optimization algorithms can minimize the loss on a training set, machine learning is concerned with minimizing the loss on unseen samples.

The framework to apply Machine Learning for P-F Curves in the platform of the invention is given in FIG. 5. The ‘Parameters’ for the model are the detectable-defining-characteristic of the failure mechanism (example: vibration g's for bearing failure, thickness for brake pad wear out). ‘Inputs’ are the data from the current operating conditions (current reading, time elapsed, average maintenance response time, repair cost). With these set up, a P-F Curve can be generated that establishes the Potential Failure point and the P-F Interval. Maintenance team should use this information in deciding the appropriate action on the asset. This framework is best executed when the outcome from it is used as feedback to improve its set up. The P-F interval predicted by the algorithm can be used to modify the ‘Inputs’ (F_{b}) in the form of changing the maintenance response time, work order priority, or data collection frequency. The accuracy of the prediction (Goodness-of-fit) can be evaluated to identify additional parameters (F_{c}) that are influencing the failure mechanism and can be added as ‘Parameters’ to monitor. The outcome of the decisions made by the Maintenance Team can also be used to improve the setup of the P-F Curve (Fₐ) by validating the mechanism being observed and the ‘Parameters’ & ‘Inputs’ used.

Applying Machine Learning tools to generate P-F Curves negates the practical short-comings of the curve such as the curve not being up to date or the curve not fully capturing the failure mode behavior. The platform of the present invention generates dynamic P-F Curves that change in real-time as the operating condition changes and shall also use multivariate regression analysis to capture the effects of all input parameters of a failure mode to model its performance degradation.

Dynamic P-F Curves

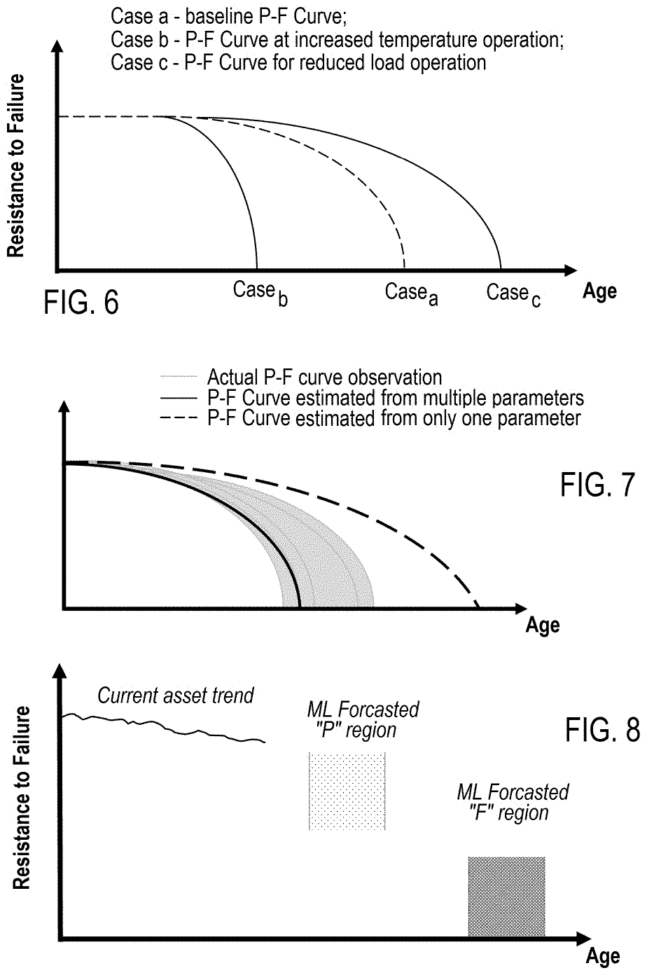

When the data being fed into the Regression Analysis is dynamic, the analysis provides dynamic model equations with the input ‘Parameter’ as its variable. When this input parameter changes unexpectedly-due to Operator Error or Increased load or External Stress—then the equation plots a different curve. This change can predict the new curve path and plot the new Failure state immediately. For example, in FIG. 6: Curve A shows the predicted P-F Curve under normal operating conditions predicted from historical normal operation data. Curve B shows the P-F Curve for the same asset changing due to an increase in output demand. The P-F interval may also change due to its increased degradation and the P point changes correspondingly to give the maintenance team ample time to respond.

The change in stresses should be recorded quantitatively using additional data collection sensors pertinent to the failure mechanism chosen. Accumulation of fatigue is be calculated from this data as Stress x Time where ‘Stress’ is the amplitude and ‘Time’ is the time spent at this amplitude. With this data, a P-F Curve should be plotted at each fatigue levels for the same asset. Collecting dynamic curves of an asset over time will enable the Reliability Engineer to record the range of behavior in all use cases.

Multivariate P-F Curves

If a critical asset has a failure mode, that is influenced by more than one ‘Parameter’ then a multivariate regression analysis can be used to plot the P-F Curve. For relevant background on relevant regression analysis see W. Chen and G. Zhao, “A Multivariate Correlation Degradation Model for Reliability Analysis Based on Copula,” 2020 Reliability and Maintainability Symposium (RAMS), 2020, pp. 1-6; and Li H, Li R, Li H, Yuan R. Reliability modeling of multiple performance based on degradation values distribution. Advances in Mechanical Engineering. October 2016.

The choice of parameters will depend on the failure mechanism and driven by the knowledge of the maintenance team. The maintenance team can use the literature to understand the physics of failure (PoF) or conduct own experiments (Reliability Testing) to determine the significant parameters affecting the failure mechanism. These parameters will be monitored continuously to feed into an algorithm and estimate the baseline degradation model with high confidence level. This method can be combined with the dynamic method described above to plot multivariate dynamic P-F Curves.

While combining the methods of plotting a P-F Curve using Machine Learning with the platform of the present invention, it is evident that the algorithm can give the RE insights on where the points of the P-F Curve are expected to be based on the current asset trend data. This is represented in FIG. 8 and uses a combination of extrapolation data and the historical trend of assets in the same population. This awareness will help the maintenance team in planning for the expected intervention; either for detection of imminent failure at “P” point or the observation of actual functional failure at “F” point.

There are general things to consider while developing a maintenance program with machine learning including: i) Choice of asset, failure mode, and parameter: Use Criticality Analysis methods to determine the dominant failure mechanism of the critical asset and implement Machine Learning solution on it; ii) Data integrity: The data that is used to plot P-F Curve should have the attributes for machine learning. Corrupt or unlabeled data will lead to inaccuracy in the results; iii) Using the correct algorithm: The type of decision that the Maintenance team intends to make will determine the choice of the algorithm—regression, clustering, or classification; iv) Integrating with the Maintenance Program: Using Machine Learning tools as a standalone solution will not improve the effectiveness of the Maintenance program unless it is integrated with the workflow of the Maintenance Program. Any alerts generated by the dynamic P-F Curve must be notified and worked on by the Maintenance Team with priority determined by the estimated Net P-F interval and the current P Point.

The platform of the present invention represents an effective practical solution at present. Further the field of Machine Learning is advancing at breakneck pace with new algorithms, capabilities, and features. The usability of the platform of the invention as a new tool for Reliability & Maintenance will be expanded through development of each new practical solutions with the installing of the data collection infrastructure, training users on data analysis & interpretation. There will be a need, however, for an industry wide guidance on the implementation & operation of Machine Learning augmented Maintenance Program.

The above description is representative of the present invention but not restrictive thereof. The full scope of the present invention are set forth in the appended claims and equivalents thereto.

What is claimed is:

1. A reliability engineering software tool for scheduling maintenance events of at least one industrial asset comprising:
at least one identified physical mechanism of failure for the at least one asset and at least one identified precise evidence for each identified physical mechanism of failure for the at least one asset;
a monitor for each identified precise evidence for each identified physical mechanism of failure for the at least one asset over time to obtain multiple inputs for each identified precise evidence for each identified physical mechanism of failure for the at least one asset;
a machine learning based tool dynamically plotting a P-F curve based upon inputs including the monitoring of each identified precise evidence for each identified physical mechanism of failure for the at least one asset over time; and
a schedule of maintenance events created based upon the dynamically plotted P-F curve of at least one asset.

2. The reliability engineering software tool according to claim 1 wherein the dynamically plotted P-F Curve is used to establish a potential failure point and a P-F interval predicted for the asset.

3. The reliability engineering software tool according to claim 2 wherein P-F interval predicted by the tool is used to modify the inputs in the form of one of changing a maintenance response time, a work order priority, or a data collection frequency.

4. The reliability engineering software tool according to claim 3 wherein P-F interval predicted by the tool is used to identify additional precise evidence parameters to be monitored.

5. The reliability engineering software tool according to claim 2 wherein the machine learning based tool utilizes multivariate regression analysis to capture the effects of all input parameters of a failure mode to generate the dynamically plotted P-F Curve.

6. The reliability engineering software tool according to claim 5 further including a range of asset behavior over varied use cases is created from the dynamically plotting a P-F curve based upon inputs including the monitoring of each identified precise evidence for each identified physical mechanism of failure for the at least one asset over time.

7. The reliability engineering software tool according to claim 5 wherein P-F interval predicted by the tool is used to identify additional precise evidence parameters to be monitored.

8. The reliability engineering software tool according to claim 2 further including a range of asset behavior over varied use cases is created from the dynamically plotting a P-F curve based upon inputs including the monitoring of each identified precise evidence for each identified physical mechanism of failure for the at least one asset over time.

9. The reliability engineering software tool according to claim 8 wherein P-F interval predicted by the tool is used to identify additional precise evidence parameters to be monitored.

10. The reliability engineering software tool according to claim 2 wherein P-F interval predicted by the tool is used to identify additional precise evidence parameters to be monitored.

11. A reliability engineering software method for scheduling maintenance events of at least one industrial asset comprising:
identifying at least one physical mechanism of failure for the at least one asset and at least one precise evidence for each identified physical mechanism of failure for the at least one asset;
monitoring each identified precise evidence for each identified physical mechanism of failure for the at least one asset over time to obtain multiple inputs for each identified precise evidence for each identified physical mechanism of failure for the at least one asset;
dynamically plotting a P-F curve based with a machine learning tool based upon inputs including the monitoring of each identified precise evidence for each identified physical mechanism of failure for the at least one asset over time; and
scheduling of maintenance events based upon the dynamically plotted P-F curve of at least one asset.

12. The software method for scheduling maintenance events according to claim 11 wherein the dynamically plotted P-F Curve is used to establish a potential failure point and a P-F interval predicted for the asset.

13. The software method for scheduling maintenance events according to claim 12 wherein P-F interval predicted is used to modify the inputs in the form of one of changing a maintenance response time, a work order priority, or a data collection frequency.

14. The software method for scheduling maintenance events according to claim 13 wherein P-F interval predicted is used to identify additional precise evidence parameters to be monitored.

15. The software method for scheduling maintenance events according to claim 12 wherein the machine learning based tool utilizes multivariate regression analysis to capture the effects of all input parameters of a failure mode to generate the dynamically plotted P-F Curve.

16. The software method for scheduling maintenance events according to claim 15 further including a range of asset behavior over varied use cases is created from the dynamically plotting a P-F curve based upon inputs including the monitoring of each identified precise evidence for each identified physical mechanism of failure for the at least one asset over time.

17. The software method for scheduling maintenance events according to claim 15 wherein P-F interval predicted by the tool is used to identify additional precise evidence parameters to be monitored.

18. The software method for scheduling maintenance events according to claim 12 further including a range of asset behavior over varied use cases is created from the dynamically plotting a P-F curve based upon inputs including the monitoring of each identified precise evidence for each identified physical mechanism of failure for the at least one asset over time.

19. The software method for scheduling maintenance events according to claim 18 wherein P-F interval predicted by the tool is used to identify additional precise evidence parameters to be monitored.

20. The software method for scheduling maintenance events according to claim 12 wherein P-F interval predicted by the tool is used to identify additional precise evidence parameters to be monitored.
